(19) United States
(12) Patent Application Publication
(10) Pub. No.: US 2011/0040625 A1
(43) Pub. Date: Feb. 17, 2011

(54) SYSTEM AND METHOD FOR ADVERTISING ON A MOBILE DEVICE

(76) Inventors: DAVID WOODRUFF, Alexandria, VA (US); John A. Werner, Washington, DC (US)

Correspondence Address: BRIAN KOLO, 43586 PURPLE ASTER TERRACE, LEESBURG, VA, 20176, US

(21) Appl. No.: 12/030,114

(22) Filed: Feb. 12, 2008

(51) Int. Cl. G06Q 30/00

(52) U.S. Cl. 705/14.58; 705/14.64

(57) ABSTRACT

The present invention is comprised of a computer system and software used to track and recall useful information related to a users presence relative to a geographical landmark. This invention may be used to recall personal contact information of individuals related to the geographical location. Additionally, the invention may be used to advertise features related to the location such as local stores, sales, specials or upcoming events.

### BACKGROUND OF THE INVENTION

The explosive growth of the global mobile phone industry is unquestioned. Today nearly 200 million Americans have mobile phones. By 2007, there are expected to be as many mobile phones in Western Europe as there are Western Europeans. Already, Sweden boasts a 100.1% market penetration.

Mobile phones have changed the way in which Americans use telecommunications, and in response, American lawmakers have updated telecommunications policy to ensure it matches this new marketplace.

One such policy is the requirement for enhanced 911, or E911. The policy was born from the concern that with more and more Americans using cell phones exclusively, a call to 911 from a mobile phone will not be geographically traceable in the way in which a traditional landline phone is associated with a fixed address.

The FCC has given U.S. wireless carriers until Dec. 31, 2005 to have 95% of their subscribers using devices which are able to support systems which provide geographic location embedded in calls to 911.

While there is an industry effort to secure a brief delay in the deadline, it is clear that the day in which all mobile telecommunication devices are GPS enabled or geographically aware will soon be upon us.

With 200 million wireless devices in use in the United States, this is a tremendous market.

Cellular phone companies presently have a wide coverage of access throughout the United States. Many of these companies offer additional services beyond traditional phone services such as internet access and text messaging.

Additionally, WiFi access is becoming commonplace in the United States. Many local businesses are offering paid or free access to WiFi networks. Some municipalities have already implemented or plan to implement WiFi access within their borders.

The availability of communications over WiFi and/or cellular phone towers provides additional capabilities to locate a user within a specific predetermined geographic region.

### BRIEF SUMMARY OF THE INVENTION

The present invention is directed toward providing a user contact information for individuals related to the current geographical location of the user.

The present invention is also directed toward providing a user customized advertisements related to the current geographical location of the user.

The present invention is also directed toward providing a user with a computer system and software which learn user preferences based on the geographical location of the user.

The present invention is also directed toward establishing a system to devise metatags of geographic data assigned to each action or transaction in a mobile phone or similar electronic device for the purposes of storage, search, retrieval, or any manipulation.

### BRIEF DESCRIPTION OF FIGURES

The present invention will be understood more fully from the detailed description that follows and from the accompanying drawings, which however, should not be taken to limit the invention to the specific embodiments shown, but are for explanation and understanding only.

FIG. 1 is a diagram that illustrates an advertising system in accordance with some embodiments of the invention.

### DETAILED DESCRIPTION OF THE INVENTION

In the preferred embodiment, the present invention comprises a Computer and Software System. The Computer System comprises a computer processing unit connected to a User Interface unit. The Software System comprises a method to determine the present geographical location of the user.

The user moves into a geographical location and enters the name of the location using the User Interface. This creates a Named Region. For instance, the user may state the present location is “Capitol Hill.” The Software System uses a GPS location device to determine the present geographical location of the user. The Software System then records the name of the present location in a Local Database residing on the Computer System.

The user may create a plurality of such Named Regions. The Software System associates geographical areas with each named region. The Software System may define a region by associating all locations within a certain distance are part of the same region. If two regions overlap, the Software System may choose a smaller distance in order to remove the overlap. Alternatively, the Software System may prompt the user to further define the overlapping regions, allowing irregular regions. Furthermore, the Software System may simply associate overlapping areas to both regions.

As the user users the Computer System, the Software System records in the Local Database the user's activities and the geographical location. The Software System can later recall the user activities associated with the geographic region. Additionally, the Software System can be used to perform a specified action when the user enters a specific region.

For example, if the Computer System is a cellular telephone, the Software System may record all telephone calls made or received with the user is present in the Named Region. Furthermore, if the user adds a new telephone number, the Software System may record the location of the user when the information is entered. Later when returning to the same region, the Software System may present the user with a list of contacts in the region or a list of calls made or received wile in the region.

Additionally, the information presented on the Computer System may vary depending on the present geographical location of the user. For instance, if the user has stored a series of personal contacts and associated those contacts with Named Regions, the Computer System may preferentially display contacts in nearby regions. Thus, if the user is near Capitol Hill and the user begins to search a cellular phone for a phone number, the Computer System might display the phone numbers of people in Capitol Hill first. Additionally, people in Named Regions nearby might be displayed next on the list.

Furthermore, the user may be able to access the information associated with a region while the user is away from the region. This may be useful if the user wishes to review and/or update the information the Software System associates with the region. This may also be useful to the user as a mechanism to assist the user in remembering where the user was located when he received or placed a telephone call.

As another example, the Computer System may be a portable music playing device. Here, the user may create a list of songs to be played while the user exercises over a specific route. The user may program a specific list of songs to play as the user enters different segments of the exercise route. For example, the user may preprogram a particularly inspirational song to play when the user starts to climb a large hill.

In a less preferred embodiment, the Computer and Software Systems connect to a Central System through a set of communication lines such as WiFi access. This embodiment allows the Central System to control the behavior of the Software and/or Computer system.

A Central System using WiFi access is useful to present advertisements to the user when the user is located near shops or restaurants. For instance, if the Computer System is a PDA, the Software System may receive advertising information from the Central System and instruct the Computer System to display the advertisement. Thus, a user walking toward a restaurant might receive an advertisement for the restaurant. The advertisement may include a coupon or other incentive for the user's patronage.

Furthermore, the restaurant advertisement may be programmed to only be presented during certain hours. Thus, the user might receive advertisements for the restaurant near lunch or dinner times, but may not receive this advertisement when the restaurant is closed.

The invention may also be used in shopping malls to advertise shops within the mall. By using a system of short ranged WiFi nodes, shops in a limited region may preferably place advertisements to users as the walk through the mall. In this case, a series of WiFi nodes are placed throughout the shopping mall. Each node may transmit information pertaining to the shops nearby the local region of the node. The Software System may receive many signals as transmitted by all the nodes nearby. The Software System may detect the signal strength of the transmissions and preferentially choose to display advertisements from the strongest source. In doing this, the Software System will preferentially display advertisements from the nearest node. Thus, the user will experience advertisements for nearby stores. And the user moves through the mall, the stores advertising will change to the stores closest to the user. In this embodiment, no GPS locator is needed as the series of overlapping WiFi nodes can create a customized experience.

Additionally, a shopping mall may also include information in addition to store advertisements. For instance, the Computer System may display a map or the mall, business hours, or other information pertaining to the mall.

Further, in some embodiments, the system and methods include a mechanism for transmitting information from the Computer System to the store, mall, etc., wherein the information transmitted changes the behavior of the store. For example, the user may receive an advertisement from a store, and then delete the advertisement. The deletion is then tramitted to the store, who may then decide to transmit a new message to make the advertisement more “enticing.”

Additionally, this system may advertise municipal events. For instance, a municipality may display a warning about crossing busy streets during peak traffic times. Alternatively, the municipality may advertise upcoming events and provide directions to community centers.

In another embodiment, the present invention may create a method of doing business. In this case, the administrator of the Central System may charge for advertising time on the system. This provides an incentive for the administrator to construct a WiFi network covering a business area. The administrator may then recover this investment cost and return a profit by selling advertisements to the businesses covered by the network.

The Central System may be programmed for flexible presentation of the advertisements. For instance, an ice cream shop may pay a regular rate to have its advertisements run during the summer. However, the ice cream shop owner may setup the advertisements so that they are played more frequently on unusually hot summer days. In this case, the Central System would monitor the temperature during the day, and when the temperature exceeded a threshold, the ice cream shop advertisements start to play more frequently.

The Central System may be programmed to allow flexible play based on factors such as time of day, day of the week, holidays, mall traffic patterns, temperature, weather conditions (rain, sleet, hail, sunshine, cloudy, moonlight, humidity), or any other quantity.

### Other Embodiments

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the communication lines disclosed herein are intended to represent exemplary functional relationships and/or physical couplings between the various entities. It should be noted that many alternative or additional functional relationships or physical connections may be present in a practical electronic transaction or transmission.

In another embodiment, the system uses the wireless device's geographic location system to assign a geographic marker or geographic metatag to every action that is carried out—phone call made, name added to address book, item written in the to-do list.

In addition, users would able to “teach” their device about its surrounds, i.e. location of work, home, grocery store, and other frequently visited areas.

These geographic markers, like any other item in the databases, are searchable through a wide variety of parameters. These parameters may include date of creation, time of creation, GPS location, consumer provided text (subject, title, description, etc.), and user responsible for the creation of the record, or any environmental factor (weather, humidity, temperature, or any other environmental factor).

It should be appreciated that the user interface need not be limited to visual computer displays but may include auditory or tactile interfaces. Auditory and tactile interfaces may also be used to assist visually or hearing impaired users.

It should also be appreciated that the user interface may be from a phone capable of monitoring position through an embedded GPS device.

It should also be appreciated that the Software System may be preloaded with Named Regions.

It should also be appreciated the Local Database need not reside on the Computer System. The data may be transmitted via the communication lines to a location remote to the Computer System. This may be part of the Central System, or this may be part of another system. The data is then stored in this remote location and accessed by the Software or Computer system as needed.

It should also be appreciated that the communication lines described above may be of various types. For instance, the Computer System may connect to the Central System using a VPN, secured internet connection, private network, static route, point-to-point connection, frame relay, or wireless connection.

It should also be appreciated that the Central System may be comprised of multiple computers, multiple databases, and/or multiple software systems.

It should be appreciated that the communications lines described herein may include any system for exchanging data or transacting business, such as Internet, intranet, extranet, WAN, LAN, satellite communication, cellular phone communications, and the like. Further, the communications between entities concerning the transaction or access request can occur by any mechanism, including but not limited to, Internet, intranet, extranet, WAN, LAN, point of interaction device (point of sale device, personal digital assistant, cellular phone, kiosk, etc.), online communication, off line communication, and wireless connection. The present invention might further employ any number of conventional techniques for data transmission, signaling, data processing, network control, and the like. For example, radio frequency and other wireless techniques can be used in place of any network technique described herein. It is further contemplated that communications can occur sequentially, in parallel, or that two or more communications may be sent as one communication.

It should also be appreciated that the Computer System may be of various characters. This device may a PDA, PALM, Pocket PC, laptop computer, tablet PC, text message, SMS or cellular phone.

In each of the above embodiments, the different, specific embodiments of invention are disclosed. However, it is the full intent of the inventor of the present invention that the specific aspects of each embodiment described herein may be combined with the other embodiments described herein. Those skilled in the art will appreciate that various adaptations and modification of the preferred embodiments can be configured without departing from the spirit and the scope of the invention. Therefore, it is to be understood that the invention may be practiced other than that specifically described therein.

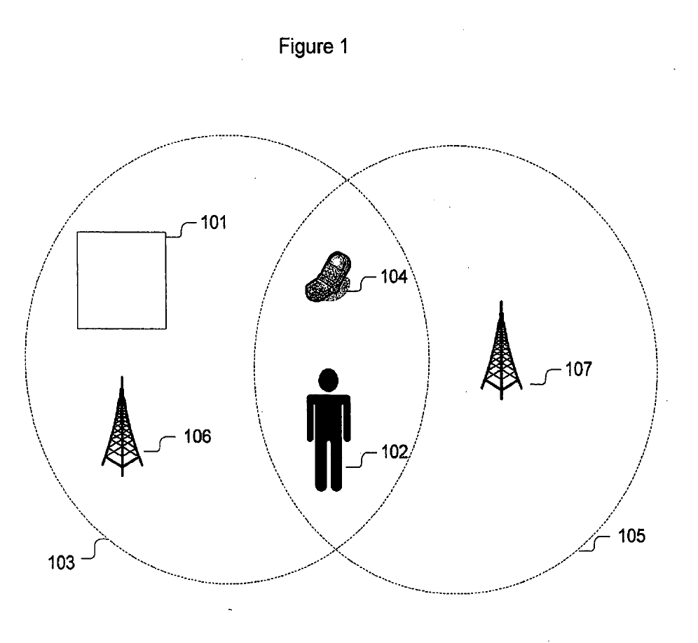

FIG. 1 describes one embodiment of the invention. Here, a local store 101 desiring to advertise their ware to shoppers 102 who are located geographically close to the store, where the advertisements are pushed onto a shopper's cell phone 104. The cell phone may be any type of mobile device, including PDA, blackberry, and the like. The shopper's presence within the geographical location may be determined by any any means. For instance, in one embodiment, the store is located within a wifi hot spot, so that each node 106 and 107 transmit information pertaining to the shop 101 nearby the local region of the node 106 and 107. Software System placed upon the cell phone 104 may receive many signals as transmitted by all the nodes 106 and 107 nearby. The Software System may also detect the signal strength of the transmissions and preferentially choose to display advertisements from the strongest source. Thus, the Software System may use triangulation, i.e., determination of the location of the cell phone 104 by comparing radial distance or direction of the received signal from two or three different points, i.e., 106 and 107. In an alternate embodiment, the geographical location of the shopper 102 is determined by cell phone-based GPS techniques. Further, it is contemplated that any tracking technique may be used.

When the Central System determines the cell phone 104, and thus the shopper 102, are located within a desired distance from the store 101, the Central System may then push advertising information onto the cell phone 104. Thus, a shopper 102 walking toward a restaurant 101 might receive an advertisement for the restaurant. The advertisement may include a coupon or other incentive for the user's patronage.

If the nodes 106 and 107 are cell phone towers, then a Central System located on the cell phone or PDA may then be able to perform triangulation. Alternatively, the cell phone 104 transmits a signal to the towers 106 and 107, and a computer located anywhere on the cell phone network may perform the calculation.

1. A method for advertising within a geographical location, said method comprising
wirelessly transmitting an electronic message comprising an advertisement to a mobile device located within a predetermined geographical location.
